(19) United States
(12) Patent Application Publication
(10) Pub. No.: US 2008/0163118 A1
(43) Pub. Date: Jul. 3, 2008

(54) Representation of file relationships

(76) Inventor: Jason Wolf, Los Gatos, CA (US)

Correspondence Address: BRAKE HUGHES BELLERMANN LLP, C/O INTELLEVATE, P.O. BOX 52050, MINNEAPOLIS, MN, 55402, US

(21) Appl. No.: 11/648,204

(22) Filed: Dec. 29, 2006

(51) Int. Cl. G06F 3/048

(52) U.S. Cl. 715/835

(57) ABSTRACT

A first visual icon representing a first grouping of files from a plurality of files associated with file properties may be displayed. Relationships between the first grouping and one or more secondary groupings from the plurality of files may be determined, based at least in part on the file properties. Secondary visual icons representing the one or more secondary groupings may be displayed around a perimeter of the first visual icon in a star topology. Relationship indicators associating the secondary visual icons to the first visual icon may be displayed in the star topology, based on the relationships.

### TECHNICAL FIELD

This description relates to techniques for representing relationships between files.

### BACKGROUND

With the growth of computers and network technology has come a corresponding growth in the use and storage of electronic files. Electronic files can come in many different types and sizes. For example, electronic files may include e-mails, word processing documents, applications or programs, digital images, spreadsheets, web pages, games, and other electronically-stored information. Thus, any given user may have, or may access, a large number of files, including a large variety in the types of files.

For example, a user may store a large number of e-mails with varying characteristics or properties. For example, there may be e-mails to/from a variety of recipients/senders, with or without attachments. There may be e-mails with different priority levels, or e-mails with different send/receipt dates. Over time, a user may accumulate a large number of such e-mails (or other files). Consequently, it may be difficult for the user to make optimal use of such files. For example, a user may forget, or not know, that a particular file exists, or may be unable to locate a desired file. Moreover, it may be difficult for a user to keep track of relationships between e-mails, so that, again, the user may lose the benefit of having access to certain files, or to certain (types of) information about such files.

### SUMMARY

Various embodiments for representations of file relationships are disclosed. According to an example embodiment, a method is disclosed. A method may include displaying a first visual icon representing a first grouping of files from a plurality of files associated with file properties. The method may also include determining relationships between the first grouping and one or more secondary groupings from the plurality of files based at least in part on the file properties. The method may also include displaying secondary visual icons representing the one or more secondary groupings around a perimeter of the first visual icon in a star topology. The method may also include displaying relationship indicators associating the secondary visual icons to the first visual icon in the star topology, based on the relationships.

According to another example embodiment, a system is disclosed. The system may include a system for organizing files including a relationship processor configured to determine a first relationship between a first grouping of files and a second grouping of files, based on a first file property common to the first grouping of files and the second grouping of files, and a second relationship between the first grouping of files and a third grouping of files based on a second file property common to the second grouping of files and the third grouping of files. The system may also include a placement coordinator configured to determine a relative placement of a first visual icon representing the first grouping of files to both of a second visual icon representing the second grouping of files and a third visual icon representing the third grouping of files, using a star topology in which the second visual icon and the third visual icon are centrally connected to the first visual icon and displayed around a perimeter thereof. The system may also include an attribute adjuster configured to adjust at least one visual attribute associated with the first visual icon, the second visual icon, and the third visual icon, based on one or more characteristics of, respectively, the first grouping, the second grouping, and the third grouping. The system may also include a display generator configured to provide, based on the relative placement a relationship map including the first visual icon, the second visual icon, and the third visual icon, each displaying the at least one visual attribute, a first relationship indicator associating the first visual icon to the second visual icon based on the first relationship and in the star topology, and a second relationship indicator associating the first visual icon to the third visual icon based on the second relationship and in the star topology.

According to another example embodiment, a computer program product for representing an organization of e-mails is disclosed. The computer program product may be tangibly embodied on a computer-readable medium and may include executable code that, when executed, is configured to cause a data processing apparatus to provide an interface comprising a plurality of visual icons associated with groupings of a plurality of e-mails, a grouping including a selection of the plurality of e-mails grouped based at least in part on one or more properties shared amongst the selection, and arranged in one or more star topologies comprising a primary visual icon and one or more secondary visual icons placed around a perimeter associated with the first visual icon. The interface may further comprise adjustable visual attributes associated with the plurality of visual icons, the visual attributes being adjustable based at least in part on the shared properties of the groupings associated with the visual icons. The interface may further comprise one or more relationship indicators connecting the visual icons arranged in the star topologies based on relationships between the groupings of e-mails associated with the visual icons arranged in the star topologies.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for a file relationship representation system, according to an example embodiment.

FIG. 2 is a flowchart illustrating at least some example operations of the system of FIG. 1.

FIG. 3 is a block diagram of an example system for a file relationship representation system of FIG. 1, according to an example embodiment.

FIG. 4 is a block diagram of another example system for a file relationship representation system of FIG. 1, according to an example embodiment.

FIG. 5 is a flowchart illustrating at least some example operations of the systems of FIGS. 1, 3, and 4.

### DETAILED DESCRIPTION

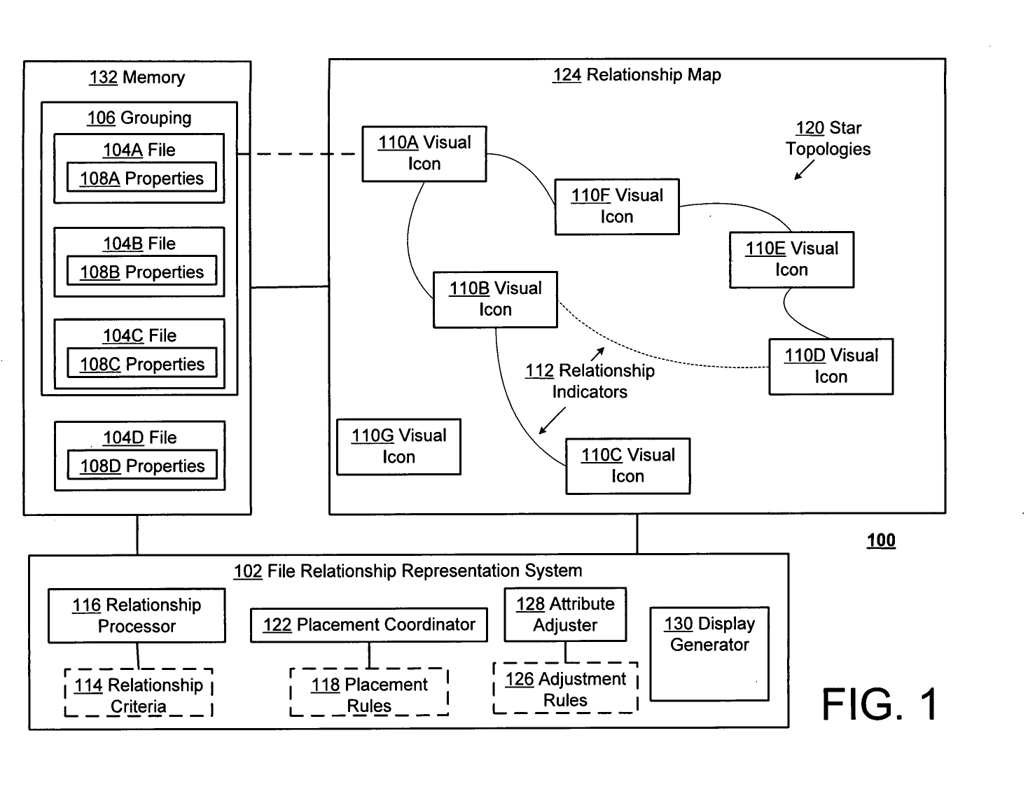

FIG. 1 is a block diagram of an example system 100 for a file relationship representation system 102, according to an example embodiment. In the example of FIG. 1, the system 100 may display relationships between files or groups of files, as well as characteristics thereof, in an intuitive manner that allows a user to quickly and easily grasp information about the files or groups of files. For example, the system 100 may allow a user to quickly locate a file or group of files of interest, without having to manually parse or open an excessive number of folders or files. The system 100 also may allow a user to quickly see changes within the groups of files, such as when a file is added or removed from a group, in a manner that visually conveys such information, even for a large number of files.

As just referenced, the file relationship representation system 102 may include, by way of example, an application, device, or grouping of components configured to display an organization of files. The file relationship representation system 102 may, for example, provide a display of an existing file organization and/or may allow a user to define how to organize a plurality of files or group of files. According to an example embodiment, the file relationship representation system 102 may create and update the display based on properties of, or change(s) in, a plurality of files 104A, 104B, 104C and 104D. For example, such properties or changes may include a creation or receipt of a new file, or a deletion or modification of an existing file.

The files 104A-D may include documents, images, e-mails, web pages, and/or other files. For example, the files 104A-D may all be e-mails, or the files 104A-D may include a mix of file types; for example, the file 104A may be a word processing document, the file 104B may be a digital picture, and the files 104C-D may be web pages.

At least some of the files 104A-D may be grouped into one or more groupings, including the grouping 106, as shown. The groupings may include one or more files 104A-D grouped based upon some shared characteristic (e.g., a file property), where such shared characteristic(s) may be based on, or determined from, a user preference. For example, the files 104A-C may be included in the grouping 106 because they may be associated with a project a user is working on. According to an example embodiment, the grouping 106 may correspond to a folder of files on an underlying file management application, or other application, or an underlying operating system. For example, the files 104A-C may be included in a folder labeled “Project X,” while the file 104D may be included in another folder labeled “Project Y”

According to an additional or alternative example embodiment, the files 104A-D may be grouped into one or more groupings, including the grouping 106, based on (file) properties 108A, 108B, 108C, and 108D. The properties 108A-D may include information about the files 104A-D, respectively. In an example embodiment, the files 104A-D may be e-mails, and the properties 108A-D may include information such as sender/recipient, destination address(es), subject, whether attachments exist, priority, whether replied to, size, and/or other information.

Then, for example, the files 104A-C may be grouped into the grouping 106 based on a shared property and/or common characteristic that may be shared amongst the files 104A-D. For example, the files 104A-C may all be from ‘Sender A’ while the file 104D may be from ‘Sender B.’ Or, in another example, the files 104A-D may all be from ‘Sender A,’ but the files 104A-C may be included in the grouping 106 because the properties 108A-C indicate the files 104A-C include attachments, wherein properties 108D indicate that the file 104D does not include attachment(s). According to an example embodiment, a grouping may include zero files; if for example, the grouping is defined as including files created within the past 3 months, when, in fact, all of the files 104A-D were created six months ago or more.

Visual icons 110A, 110B, 110C, 110D, 110E, 110F and 110G may include shapes, images, graphics, text and/or other representations of one or more corresponding grouping(s). Thus, for example, the visual icon 110A may represent the grouping 106. Then, for example, the visual icons 110B-G may each represent additional, corresponding groupings (not shown). The additional groupings may include, for example, sub-groupings of the grouping 106, groupings that share at least one common file with the grouping 106, groupings with completely different files or file properties but that share some other characteristic with the grouping 106, or groupings that share no common characteristics/properties with the grouping 106 (that are of interest).

The visual icons 110A-G may include visual attributes used to indicate useful information to the user, e.g., about individual file properties, files, or groupings of files. Consequently, the visual attributes may be adjusted based on user preferences, in order to convey desired information in a desired way. The visual attributes may include, but not be limited to, for example, a shape, color, size, line thickness, transparency, labeling, shadow boxing, movement, and/or highlighting of the visual icon(s) 110A-110G For example, the visual icon 110A may be a red circle representing a grouping of new files received with the past seven days and the visual icon 110B may be a blue square representing a grouping of files from ‘Sender X’ that include attachments.

Relationship indicators 112 may associate pairs of the visual icons 110A-G to one another based on relationships between the groupings represented by the visual icons 110A-G. For example, the relationship indicators 112 may connect the visual icon 110A with the visual icons 110B and 110F, based on relationships between the groupings represented by the connected visual icons 110A/110B and 110A/110F. Groupings of files (such as the grouping 106) may be related through a sharing of a common file or file property, or may have a set/sub-set relationship. Such relationships between groupings, and other example relationships, are discussed in greater detail below.

The relationship indicators 112 may include visual attributes that are adjustable based on a relationship between the respective groupings of two or more visual icons, and/or based on user preference. For example, the relationship between the groupings represented by the visual icons 110B and 110C may be different from the relationship between the groupings represented by the visual icons 110B and 110D. For example, the grouping represented by the visual icon 110C may be a sub-grouping of the grouping represented by the visual icon 110B, whereas the grouping represented by the visual icon 110D may include different files than the grouping represented by the visual icon 110B, but may share a similar file property or other characteristic.

Relationship criteria 114 may include rules or criteria associated with determining whether and/or what kind of relationship exists between two or more groupings or files 104A-D. Example relationships between a first grouping and a second grouping may include, but not be limited to, the second grouping being a sub-grouping or subset of the first grouping, the second grouping being associated with a sub-folder of a folder associated with the first grouping, the two groupings sharing a common file, and/or the two groupings sharing a file property or other characteristic. Also, it may be the case that the first grouping and the second grouping share nothing (of interest) in common with one another, so that no relationship (as defined by the relationship criteria 114) exists between them.

As just referenced, the relationship criteria 114 may specify that a relationship exists between two or more groupings that share one or more of the properties 108A-D. For example, the files 104A-D may include the properties 108A-D which may include, for example, author, creation date, and size. Then, for example a first grouping represented by the visual icon 110E may include the files 104A-D with author “Joe Smith,” a second grouping represented by the visual icon 110D may include the files 104A-D with creation date ‘before September 2006’ and a third grouping represented by the visual icon 110F may include the files 104A-D with size ‘less than 500 kb.’

Then for example, the properties 108A may indicate the file 104A includes ‘author: Joe Smith,’ ‘created: May 2005,’ and size ‘501 kb,’ and the properties 108B may indicate the file 104B includes ‘author: Joe Smith,’ ‘created: November 2006,’ and size ‘367 kb,’ Thus, based on the example relationship criteria 114, a first relationship may exist between the groupings represented by the visual icons 110E and 110D that share the file 104A, and a second relationship may exist between the groupings represented by the visual icons 110E and 110F that share the file 104B. Then, for example the first relationship and the second relationship may be indicated by the relationship indicators 112 connecting the visual icon 110E to both the visual icons 110F and 110D, as shown.

A relationship processor 116 may determine relationships between two or more groupings of the files 104A-D, based on the relationship criteria 114. For example, based on the relationship criteria 114, the relationship processor 116 may parse or compare the grouping(s) 106, the files 104A-D, the file properties 108A-D and/or other characteristics to determine the relationships, as discussed herein.

According to an example embodiment, the relationship processor 116 may be configured to receive relationship determination requests. For example, a user may enter a key combination, or may drag-and-drop one of the visual icons 110A-G over another one of the visual icons 110A-G to request the relationship processor 116 to make a relationship determination about the groupings associated with the selected two visual icons. The relationship processor 116 may then compare the groupings based on the relationship criteria 114 to determine whether any relationships exist between the two groupings (e.g., whether a common file exists within the two groupings).

If, for example, a relationship is determined to exist, then the relationship may be illustrated in multiple ways. According to a first example embodiment, the relationship may be provided by connecting the visual icons 110A-G with relationship indicators 112 signifying the relationship. According to a second example embodiment, a new visual icon 110H (not shown) may be created wherein the two visual icons associated with the groupings are connected to the new visual icon 110H via relationship indicators 112.

Placement rules 118 may include rules or criteria associated with determining where to place the visual icons 110A-G and/or the relationship indicators 112. Example placement rules 118 may include a first rule stating that if a relationship exists between the groupings represented by two visual icons 110A-G, then the visual icons 110A-G must be placed within a certain perimeter or other distance of each other; a rule stating that two of the visual icons 110A-G may not be placed overlapping one another; a rule stating that the visual icons 110A-G may be moved by a user providing the movements comply with the other existing placement rules 118. Other example placement rules 118 may include rules characterizing how the relationship indicators 112 should or must be placed. For example, the placement rules 118 may include a rule stating that the relationship indicators 112 must connect two visual icons 110A-G with relationships by the shortest possible distance, and a rule stating that the relationship indicators 112 may not overlap the visual icons 110A-G or other relationship indicators 112.

The placement rules 118 may include rules stating whether and how the visual icons 110A-G may be placed in star topologies 120. The star topologies 120 may include a topology or design term commonly known in the field of networking, wherein a plurality of nodes may be connected to a central hub or concentrator. In the example system 100, the star topologies 120 may similarly include a primary visual icon connected to one or more secondary visual icons, wherein relationships exist between the groupings represented by the primary visual icon and the secondary visual icons.

For example, a relationship may exist between the groupings represented by the visual icon 110A and the groupings represented by the visual icons 110F and 110B. Then, for example, the visual icon 110A may be the primary visual icon connected to the secondary visual icons 110B and 110F in a star topology 120. Then, for example, the secondary visual icons 110B and 110F may be primary visual icons in separate star topologies 120, wherein the visual icon 110B may be the primary visual icon for the secondary visual icons 110A, 110C and 110D and the visual icon 110F may be the primary visual icon for the secondary visual icons 110A and 110E.

In another example embodiment, a grouping represented by a visual icon may not currently share a relationship with any other grouping, in which case a single visual icon may be its own star topology 120 (e.g. visual icon 110G). As will be appreciated, however, and as described in more detail herein, it may later occur that such a relationship may come into being, such as when a new file (e.g., e-mail) is created that is included within the grouping of the visual icon 110G and the grouping of the visual icon 110C. In this case, the relationship processor 116 may determine the existence of the relationship of a common file, and new relationship indicator may be drawn between the visual icons 110G and 110C, e.g., using the placement coordinator 122 and subject to the placement rules 118.

The secondary visual icons may be distributed around a perimeter, periphery, or circumference of their corresponding primary visual icon. Consequently, the secondary visual icons, and/or the relationship indicators 112 connecting the primary visual icons to the secondary visual icons in the star topologies 120, may define angles between them with the primary visual icon at a vertex of the angle(s). For example, a primary visual icon may be considered to be the vertex of a circle, ellipse, square, triangle or other shape or formation wherein the secondary visual icons may be placed around the perimeter of the formation. Then, for example, a primary visual icon (e.g. the visual icon 110B) may be connected to multiple visual icons (e.g. the visual icons 110A, 110D and 110C) in a star topology, as shown. The angles between the relationship indicators 112 connecting the secondary visual icons 110A, 110D and 110C to the primary visual icon 110B (or, similarly, angles between the secondary visual icons 110A, 110D, and 110C themselves and the primary visual icon 110B) may, for example, be defined with respect to the degrees, radians, minutes of an arc, or other angular measurement(s) around the primary visual icon 110B, e.g. Rules governing the creation and display of the star topologies 120, among other rules as discussed above, may be included in the placement rules 118.

A placement coordinator 122 may enforce and/or implement the placement rules 118. For example, a user may select the visual icon 110E and move it on top of, or in a vicinity of, the visual icon 110G. Then, for example, the placement coordinator 120 may not allow the move and may return the visual icon 110E to its original position based on the placement rules 118, or may position the visual icon 110E in a permitted manner. In an another example, if a new visual icon 110H (not shown) is created, the placement coordinator 122 may determine where on a relationship may 124 to place the new visual icon 110H (and its corresponding relationship indicators 112) based on the placement rule 118.

The relationship map 124 may include or represent a display or interface configured to provide a representation of an organization of files 104A-D or groupings, as discussed above. For example, as discussed above, the relationship map 124 may display the visual icons 110A-G organized into the star topologies 120 and connected via the relationship indicators 112.

Adjustment rules 126 may include rules or criteria for adjusting visual attributes associated with the visual icons 110A-G and/or the relationship indicators 112. The adjustment rules 126 may depend upon the occurrence and/or non-occurrence of an event associated with the groupings, the files 104A-C and/or the properties 108A-C. Example adjustment rules 126 may include a rule stating that the visual icons 110A-G are to pulsate, increase in size by 25% and become centered on the relationship map 124 upon the receipt of a new e-mail into the grouping(s) associated with the new e-mail; a rule stating that the visual icons 110A-G associated with groupings containing files more than a month old are to turn into blue triangles; a rule stating the visual icon 110C is to double in size and become highlighted in yellow when the grouping associated with the visual icon 110 receives a new e-mail from “Joe Smith;” and a rule stating that when groupings associated with two visual icons 110A-G share multiple relationships, the relationship indicators 112 associating the two visual icons 110A-G should become purple and include a line thickness of “0.5 mm.”

An attribute adjuster 128 may enforce and/or implement the adjustment rules 126. For example, a new e-mail may be received and determined to be associated with the grouping represented by the visual icon 110B. Then, based on the example adjustment rules 126 above, the visual icon 110B may be increased in size by 25%, centered and begin pulsating until the receipt of the new e-mail is acknowledged by a user, at which point the visual icon 110B may return to its earlier state and/or position, according to an example embodiment.

A display generator 130 may display and/or update the relationship map 124, based on the determinations made by the relationship processor 116, the placement coordinator 122, and/or the attribute adjuster 128, e.g., as discussed above. For example, the display generator 130 may display the visual icons 110A-G and the relationship indicators 112 on the relationship map 124 as determined by the placement coordinator 120.

A memory 132 may store and/or provide the files 104A-C and/or the grouping(s). The memory 132 may include or be associated with any memory, database, operating system or other device or system configured to store and provide files or groupings of files to be accessed by the file relationship representation system 102. For example, the memory 132 may include (or be associated with) an e-mail server or inbox including a plurality of e-mails 104A-D.

According to an example embodiment, the memory 132 may receive a new e-mail 104A. Then for example, the relationship processor 116 may determine, based on the relationship criteria 114, that the e-mail 104A belongs to the groupings associated with the visual icon 110E and the visual icon 110C and that a new relationship exists and a new relationship indicator 112 may be needed to connect the visual icons 110E and 110C.

Based on the new relationship, the placement coordinator 122 may then determine a rule that the relationship indicators 112 may not pass through other relationship indicators 112 or other visual icons 110A-G. Then for example, a relationship indicator 112 connecting the visual icons 110C and 110E may be created and pass around the visual icon 110D.

The attribute adjuster 128 may then determine a rule of the adjustment rules 126 stating that if a grouping receives a new e-mail, that the visual icon 110A-G associated with the grouping is to be centered on the relationship map 124. Thus the attribute adjuster 128 may determine that the visual icons 110E and 110C may need to be centered on the relationship map 124, and that the placement of other visual icons (e.g. visual icons 110B and 110F) may need to be adjusted based on the placement rules 118.

Then, for example, the placement coordinator 122 may determine a new or adjusted relationship map 124 including the visual icons 110A-G and their current relationship indicators 112, and the new relationship indicator 112 between the visual icons 110C and 110E conforming to the placement rules 118 and adjustment rules 126, as just described. The display generator 130 may then provide or display the new or adjusted relationship map 124.

Of course, the above are merely illustrative and non-limiting examples selected to illustrate manner(s) in which the system 102 may provide the relationship map 124 in a visually-intuitive manner, so as to improve a use and enjoyment of the files 104A-104D by the user. Many other such examples exist, some of which are described below in more detail.

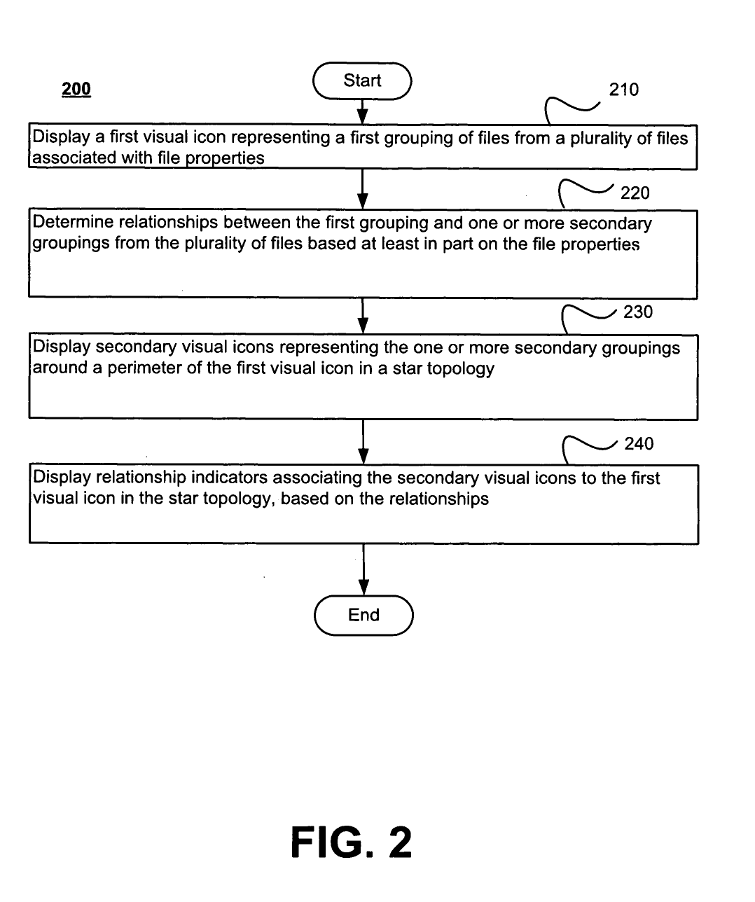

FIG. 2 is a flowchart 200 illustrating at least some example operations of the system of FIG. 1. More specifically, FIG. 2 illustrates an operational flow 200 representing example operations related to viewing relationships between files or groupings of files.

After a start operation, a first visual icon may be displayed, the first visual icon representing a first grouping of files from a plurality of files associated with file properties (210). For example, as shown in FIG. 1, the display generator 130 may display the visual icon 110A, which may represent the grouping 106, including the files 104A-C and properties 108A-C.

Relationships between the first grouping and one or more secondary groupings may be determined from the plurality of files based at least in part on the file properties (220). For example, the relationship processor 116, based on the relationship criteria 114, may determine relationships between the grouping 106 of the memory 132 and one or more other groupings by comparing the properties of the files included in the groupings.

Secondary visual icons representing the one or more secondary groupings may be displayed around a perimeter of the first visual icon in a star topology (230). For example, the placement coordinator 122, based on the placement rules 118, may determine the placement of the secondary visual icons 110F and 110B around the primary visual icon 110A in one of the star topologies 120.

Relationship indicators associating the secondary visual icons to the first visual icon may be displayed in the star topology, based on the relationships (240). For example, the placement coordinator 122, based on the relationship criteria 114 and the placement rules 118, may determine the placement of the relationship indicators 112 connecting the visual icons 110F and 110B to the visual icon 110A. The display generator 130 may then draw, display, or otherwise provide the relationship map 124 accordingly.

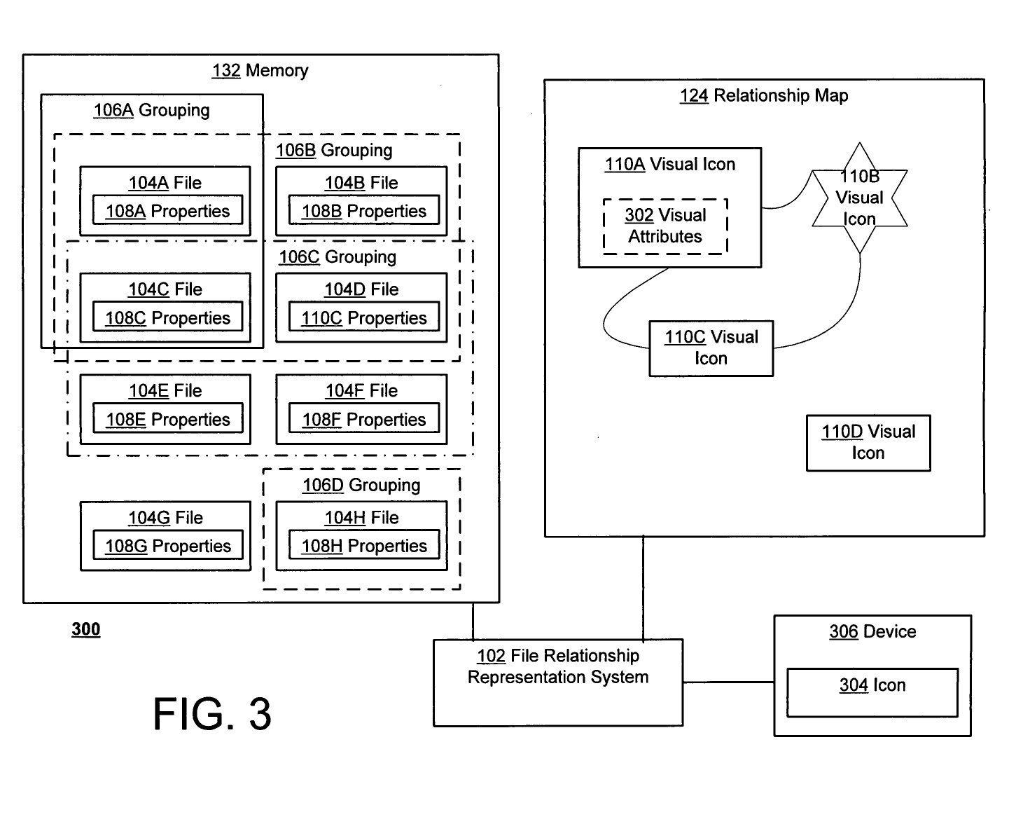

FIG. 3 is a block diagram of an example system 300 for the file relationship representation system 102 of FIG. 1, according to an example embodiment. Thus, in the example of FIG. 3, the system 300 may include components that are similar or substantially similar to like numbered components of FIG. 1.

In FIG. 3, the memory 132 may include a plurality of files 104A, 104B, 104C, 104D, 104E, 104F, 104G, and 104H, organized or grouped into a plurality of groupings 106A, 106B, 106C and 106D. For example, a user may have grouped the files into folders (not shown) on the memory 132 corresponding to the groupings 106A-D. According to another example embodiment, the files 104A, 104B, 104C, 104D, 104E, 104F, 104G, and 104H may be grouped based at least in part on shared file properties 108A, 108B, 108C, 108D, 108E, 108F, 108G, and 108H among the files 104A-H, respectively.

The file representation relationship system 102 may then, for example, read the memory 132 and represent the groupings 106A, 106B, 106C and 106D on the relationship map 132 using visual icons 110A, 110B, 110C, and 110D, respectively. The visual icon 110A may include visual attributes 302. The visual attributes 302, as discussed above, may include visual characteristics, settings, or features associated with the appearance of the visual icon 110A. Example visual attributes 302 may include, but not be limited to, shape, size, color, texture, line thickness, transparency, movement, placement and labeling. The visual icons 110B, 110C and 110D also may include visual attributes (not shown), similar to the visual attributes 302 of the visual icon 110A, to modify their appearances as well. A user, for example, may adjust or set the visual attributes 302 of the visual icons 110A to correspond or relate to characteristics of the grouping 106A with which the visual icon 110A is associated, the files 104A and 104C, and/or the properties 108A and 108C. For example, the visual icon 110A may be a large blue square which may signify something about the contents of the grouping 106A to a user; for example, that the files 104A and 104C may both have been created by “Jane Inventor.”

An icon 304 may include a representation of at least a portion of the relationship map 124. For example, the icon 304 may include a widget on an operating system desktop display, wherein an update to the relationship map 124 (for example if a new file is received in a grouping) may correlate to an update of the icon 304. According to an example embodiment, the icon 304 may begin flashing to indicate to a user that the relationship map 124 has been updated since the user last viewed it.

The icon 304 may reside or be displayed on a device 306. The device 306 may include a desktop computer, server, laptop, personal digital assistant (PDA), mobile phone, or other device configured to execute and/or communicate with the file representation system 102 and display at least the icon 304. For example, the device 304 may be a PDA including the icon 304 wherein the memory 302 may be a remote e-mail server. Then, for example, when the e-mail server is updated, i.e. a new file is received, the relationship map 124 may be updated as the new file is grouped. Then, for example, a user may become aware of the updated relationship map 124 and the new file by viewing a corresponding change in the icon 304 on the user's PDA device 306.

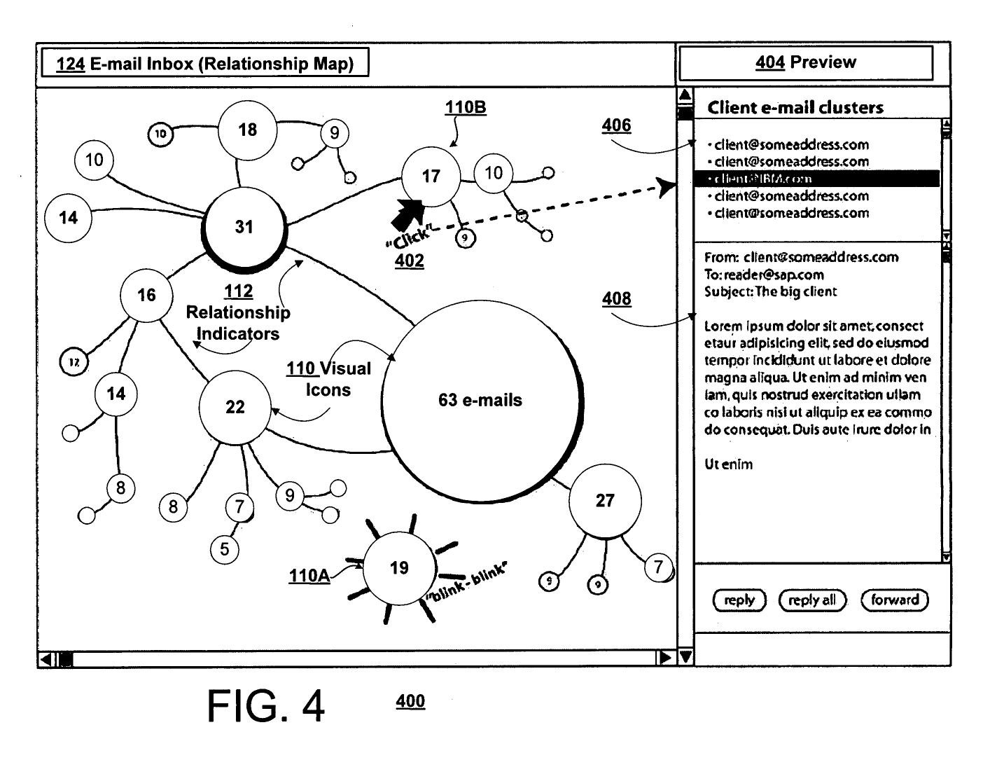

FIG. 4 is a block diagram of another example system 400 for the file relationship representation system of FIG. 1, according to another example embodiment. In the example of FIG. 4, the system 400 may include components that are similar or substantially similar to like numbered components of FIG. 1 and/or FIG. 3.

In FIG. 4, the relationship map 124 may include an e-mail inbox including a plurality of visual icons 110 representing groupings or folders of e-mails connected by relationship indicators 112. As described herein, the visual icons 110 may include visual attributes. For example, the visual attributes may include the shape of the visual icons 110 to be “circle” or “bubble,” and the label of the visual icons 110 to include the number of files or e-mails included in the grouping associated with the visual icon. For example, the visual icon with the label “31” may represent a grouping including 31 e-mails, e.g., that all share some common file property. Another visual attribute may be that the size of a visual icon 110 may correspond to the number of e-mails in the grouping and/or the importance of the e-mail(s) or the grouping represented by the visual icons 110. For example, the visual icon “63” may be the largest because it represents the most e-mails and/or because it is the most important visual icon on the relationship map 124.

The visual icon 110A may be an example of a visual attribute that may dependent upon a changing characteristic of the grouping represented by the visual icon 110A. For example, the visual icon 110A may begin to “blink” upon the receipt of a new e-mail into the grouping represented by the visual icon 110A. In other example embodiments, the blinking may represent that the grouping received an e-mail from a specific person, an e-mail with an attachment or any other characteristic of the grouping a user may decide upon. Also for example, the visual attribute of blinking by the visual icon 110A may instead be a pulsating, a rotation, a change in color, or any other change in adjustable visual attributes associated with the visual icon 110A as the user may decide upon.

The visual icons 110 may be selectable, so that, for example, a visual icon may be selected by a user to view the contents of the grouping represented by the selected visual icon. For example, a selection 402 may include a selection of one or more of the visual icons 110. For example, a user may use a mouse or other user input device (such as a keyboard) to “click” or select 402 the visual icon 110B.

Then, in response to receiving the selection 402, a preview 404 of the selected visual icon may be provided. For example, the preview 404 may include at least a portion of the contents of the grouping associated with the selected visual icon 110B. The preview 404 may include a file listing 406 and a file preview 408.

The file listing 406 may include a listing or partial listing of the file(s) of the grouping (or cluster, or other similar terminology) associated with the selected visual icon. For example, the file listing 406 may include a list of five or more e-mails included in the grouping represented by the selected visual icon 110B. Then, for example, a user may select one or more of the listed files or e-mails of the file listing 406 to see the file preview 408.

The file preview 408 may include a preview of at least a portion of the selected file(s) or e-mail(s) from the file listing 406. For example, the file preview 408 may include the content of the selected e-mail “client@IBM.com.” In another example embodiment, a visual icon 110 representing a grouping including only one file may be selected. Then for example, the file listing 406 may not appear, and/or the one file may automatically be selected and previewed in the file preview 408.

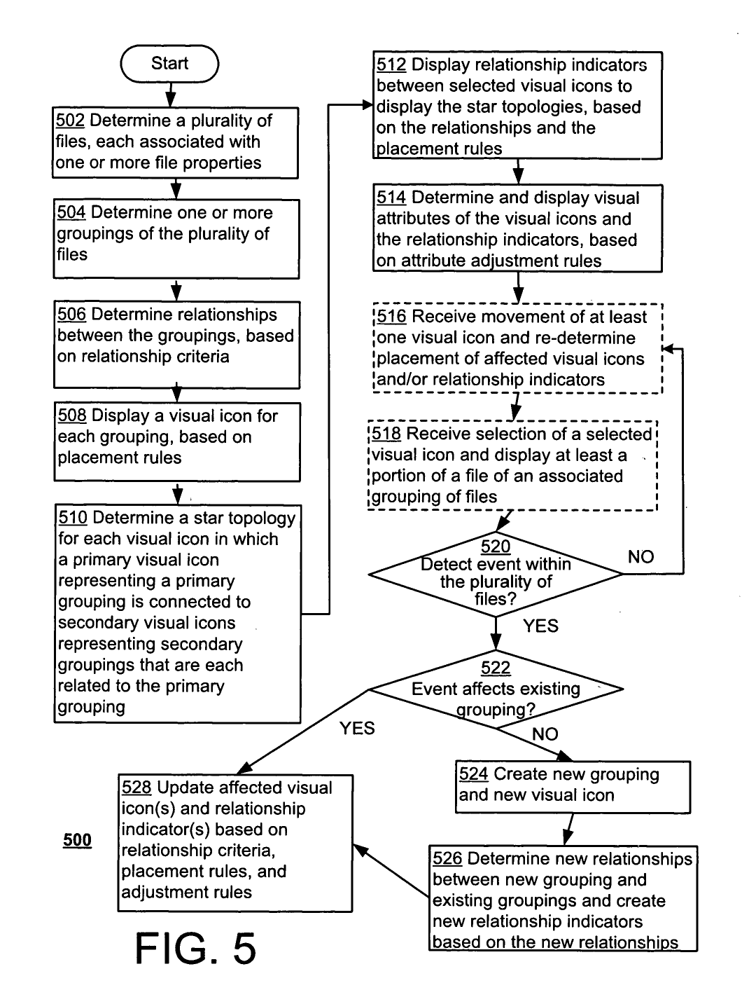

FIG. 5 is a flowchart 500 illustrating at least some example operations of one or more of the system(s) of FIG. 1, FIG. 3, and FIG. 4. More specifically, FIG. 5 illustrates an operational flow 500 representing example operations related to displaying relationships between files or groupings of files.

After a start operation, a plurality of files are determined, each of the files associated with one or more file properties (502). For example, in FIG. 1, the files 104A, 104B, 104C, and 104D are associated with the properties 108A, 108B, 108C, and 108D, respectively. For example, the plurality of files may include all of the e-mails in a user's inbox, perhaps stored on a remote server.

Then one or more groupings of the plurality of files are determined (504). For example, in FIG. 3, the groupings 106A, 106B, 106C and 106D including groups or combinations of the files 104A, 104B, 104C, 104D, 104E, 104F, and 104H. In a more specific example, groupings of the e-mails on the remote server may be defined based on properties thereof that may be of interest to a user, such as author(s) of the e-mails, sizes of the e-mails, dates of the e-mails, or senders/recipients of the e-mails.

Relationships between the groupings are determined based on relationship criteria (506). For example, the relationship processor 116 may determine, based on the relationship criteria 114, the relationships between the groupings 106A-D. For example, the relationship processor 116 may determine relationships between the groupings 106A, 106B, and 106C. As described herein, the relationships may include, for example, subset or sub-grouping relationships, such as when it is determined that all of a group of e-mails from a particular sender are a subset of a group of e-mails that have arrived in the last week. Similarly, the relationships also may include a determination of common e-mails between groups of e-mails, such as when it is determined that a first group defined as having arrived in the last week and a second group defined as being from a particular sender have overlapping files. In this case, a new grouping may be defined having both of the properties and including the common e-mails.

A visual icon may be displayed for each grouping based on placement rules (508). For example, the display generator 130 may display the visual icons 110A, 110B, 110C, and 110D associated with the groupings 106A, 106B, 106C, and 106D, respectively, based on a placement determination made by the placement coordinator 120 based on the placement rules 118. For example, the visual icons 110A-110D may be placed onto the relationship map 124 all at once (for relationship indicators 112 to be drawn in later), or may be placed onto the relationship map 124 in a serial fashion, with appropriate relationship indicators 112 being added as needed after each addition of a new visual icon 110. The placement rules 118 may dictate that the visual icons 110A-D may be placed sufficiently apart from another (e.g., distributed around the relationship map 124), or may specify that larger groupings are placed toward a middle of the relationship map 124, or may specify that certain groupings having certain properties be located close to one another (e.g., where it is expected or known that a relationship exists between such groupings).

A star topology for each visual icon may be determined, in which a primary visual icon representing a primary grouping is connected to secondary visual icons representing secondary groupings that are each related to the primary grouping (510). For example, a first star topology of the star topologies 122 of FIG. 1 may include the visual icon 110A as the primary visual icon and the visual icons 110B and 110F as the secondary visual icons. For example, such a star topology may be implemented when it is determined that emails associated with the groupings of the visual icons 110B and 110C are subsets of the e-mails of the grouping associated with the visual icon 110A.

A second example star topology of the star topologies 122 may include the visual icon 110B as the primary visual icon and the visual icons 110A, 110D and 110C as the secondary visual icons. For example, the grouping associated with the visual icon 110B may include an original e-mail to several recipients and the groupings associated with the visual icons 110A, 110D and 110C may include e-mail responses to the original e-mail by one or more of the recipients. For example, the visual icons 110A, 110D and 110C may represent groupings of the response(s) by ‘recipient A,’ ‘recipient D’ and ‘recipient C,’ respectively. In another example embodiment, the groupings represented by visual icons 110A, 100D and 110C may represent responses by all recipients within the past day, within the past week and within the past month, respectively.

Relationship indicators may be displayed between selected visual icons to display the star topologies, based on the relationships and the placement rules (512). For example, the relationship indicators 112 may connect the visual icon 110E to the visual icons 110F and 110D based on relationships as determined by the relationship processor 116 and the placement rules 118 as implemented by the placement coordinator 120.

Visual attributes of the visual icons and the relationship indicators may be determined and displayed, based on attribute adjustment rules (514). For example, the visual attributes 302 of the visual icon 110A may be determined, displayed and/or adjusted based on the adjustment rules 126.

A movement of at least one visual icon may be received, and the placement of affected visual icons and/or relationship indicators may be re-determined (516). For example, a user may move the visual icon 110B to the upper right corner of the relationship map 124. Then for example, the relationship indicators 112 connecting the visual icon 110B to the visual icons 110A, 110D and 110C may need to be adjusted based on the new placement of the visual icon 110B. Also, for example, the placement of the visual icons 110A, 110D and/or 110C may need to be adjusted based on the new placement of the visual icon 110B.

A selection of a selected visual icon may be received and at least a portion of a file of an associated grouping of files may be displayed (518). For example, a selection 402 of the visual icon 110B may be received. Then, for example, the preview 404 may be displayed including the file list 406 and the file preview 408, including a portion of a selected file from the file list 406.

An event within the plurality of files may be detected (520). If no event is detected, then, for example, the file relationship representation system 102 may wait to receive movement of a visual icon (516) and/or selection of a selected visual icon for display of a portion of a file of an associated grouping of files (518).

If an event is detected, then it may be determined whether the event affects an existing grouping (522). For example, the file relationship representation system 102 may determine whether the event affects an existing grouping 106A, 106B, 106C, or 106D. For example, the event may be receipt of a new e-mail, and received e-mail may have a property that causes the new e-mail to be added to one or more of the groupings 106A-106D.

If the event does not affect an existing grouping, then a new grouping and a new visual icon may be created (524). For example, the file relationship representation system 102 may determine the event does not affect any of the groupings 106A-106D. Then, for example, a new grouping may be created and a new visual icon 110F representing the new grouping may be displayed on the relationship map 124. Then new relationships between the new grouping and the existing groupings may be determined, and new relationship indicators may be created (526). For example, the relationship processor 116 may determine a relationship between the new grouping represented by the visual icon 110F and the grouping 106, based on the relationship criteria 114. Then, for example a new relationship indicator 112 may be created connecting the visual icon 110F to the visual icon 110A.

If the event did affect an existing grouping or after new relationships have been determined and new relationship indicators created, then affected visual icon(s) and relationship indicators may be updated based on relationship criteria, placement rules, and/or adjustment rules (528). For example, if a new visual icon 110F was created, then the placement of the new visual icon 110F on the relationship map 124 may affect the placement of existing visual icons 110A, 110B, 110C, 110D, 110E and 110G In another example, if the event did affect an existing grouping, then the visual attributes of the visual icon(s) associated with the existing grouping may need to be adjusted based on the adjustment rules 126. Then, for example, the relationship processor 116 may determine new relationships 114 based on the event. New relationship indicators representing the new relationships may then be placed on the relationship map 124 based on the relationships and the placement rules 118.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method comprising:
displaying a first visual icon representing a first grouping of files from a plurality of files associated with file properties;
determining relationships between the first grouping and one or more secondary groupings from the plurality of files based at least in part on the file properties;
displaying secondary visual icons representing the one or more secondary groupings around a perimeter of the first visual icon in a star topology; and
displaying relationship indicators associating the secondary visual icons to the first visual icon in the star topology, based on the relationships.

2. The method of claim 1 wherein the first visual icon and the secondary visual icons are associated with adjustable visual attributes, the adjustable visual attributes being illustrative of one or more characteristics, including the file properties, of the first grouping and the one or more secondary groupings, respectively.

3. The method of claim 1 wherein at least one of the secondary groupings is a sub-grouping of the first grouping, and wherein a corresponding relationship indicator between the first visual icon and a corresponding secondary visual icon is indicative of the sub-grouping.

4. The method of claim 1 wherein the one or more secondary groupings includes a common file included in the first grouping.

5. The method of claim 1 wherein displaying secondary visual icons representing the one or more secondary groupings around a perimeter of the first visual icon in a star topology comprises:
displaying the secondary visual icons connected to the first visual icon with corresponding relationship indicators, and having one or more angles between any two of the secondary visual icons defined with the first visual icon at a vertex of the one or more angles.

6. The method of claim 1 wherein displaying relationship indicators associating the secondary visual icons to the first visual icon in the star topology comprises:
displaying the relationship indicators as connecting the secondary visual icons to the first visual icon and corresponding to the relationships.

7. The method of claim 1 comprising:
displaying a secondary relationship indicator between at least two of the secondary visual icons, based on a relationship between corresponding groupings of files associated with the at least two secondary visual icons.

8. The method of claim 1 comprising:
displaying at least one of the secondary visual icons with one or more tertiary visual icons displayed around a perimeter of the at least one secondary visual icon in a secondary star topology, based on relationships between corresponding groupings of files represented by the at least one secondary visual icons and the one or more tertiary visual icons.

9. The method of claim 1 further comprising:
determining a modification associated with one or more of the plurality of files;
determining an affected grouping that includes the one or more of the plurality of files;
determining an affected visual icon associated with the affected grouping; and
determining an adjustment, if any, to the affected visual icon and any relationship indicators connected to the affected visual icon, based on the modification.

10. A system for organizing files comprising:
a relationship processor configured to determine
a first relationship between a first grouping of files and a second grouping of files, based on a first file property common to the first grouping of files and the second grouping of files, and
a second relationship between the first grouping of files and a third grouping of files based on a second file property common to the second grouping of files and the third grouping of files;
a placement coordinator configured to determine a relative placement of a first visual icon representing the first grouping of files to both of a second visual icon representing the second grouping of files and a third visual icon representing the third grouping of files, using a star topology in which the second visual icon and the third visual icon are centrally connected to the first visual icon and displayed around a perimeter thereof;
an attribute adjuster configured to adjust at least one visual attribute associated with the first visual icon, the second visual icon, and the third visual icon, based on one or more characteristics of, respectively, the first grouping, the second grouping, and the third grouping; and
a display generator configured to provide, based on the relative placement a relationship map including
the first visual icon, the second visual icon, and the third visual icon, each displaying the at least one visual attribute,
a first relationship indicator associating the first visual icon to the second visual icon based on the first relationship and in the star topology, and
a second relationship indicator associating the first visual icon to the third visual icon based on the second relationship and in the star topology.

11. The system of claim 10
wherein the relationship processor is configured to determine a third relationship between the second grouping of files and the third grouping of files, based on a common file property that is shared therebetween, and
wherein the display generator is configured to provide a third relationship indicator associating the second visual icon to the third visual icon, based on the third relationship.

12. The system of claim 10 wherein the relationship processor is configured to determine the first relationship and the second relationship based on one or more relationship criteria specifying file properties and defining the second grouping and the third grouping as different sub-groupings of the first grouping, based thereon.

13. The system of claim 10 wherein the placement coordinator is configured to determine the relative placement based on one or more placement rules, the placement rules specifying positions within the relationship map of the first visual icon, the second visual icon, the third visual icon, the first relationship indicator, and the second relationship indicator, relative to one another and relative to a newly-positioned visual icon and/or a newly-positioned relationship indicator within the relationship map.

14. The system of claim 10 wherein the placement coordinator is configured to provide further relationship indicators around a perimeter of the second visual icon and associating the second visual icon with a plurality of tertiary visual icons to form a secondary star topology therewith.

15. The system of claim 10 wherein the attribute adjuster is configured to determine adjustments associated with the first visual attribute, the second visual attribute, and/or the third visual attribute, based on one or more adjustment rules, the adjustment rules specifying correlations between the adjustments and modifications associated with the one or more of the first grouping of files, the second grouping of files, or the third grouping of files.

16. The system of claim 10 wherein the display generator is configured to provide an interface configured to provide, upon reception of a selection of one or more of the first visual icon, the second visual icon, or the third visual icon, a preview of at least a portion of the grouping of files associated with the selection.

17. The system of claim 10 wherein the display generator is configured to provide an a representation of at least a portion of the relationship map configured to provide notice of a modification associated with the first grouping, the second grouping or the third grouping.

18. A computer program product for representing an organization of e-mails, the computer program product being tangibly embodied on a computer-readable medium and including executable code that, when executed, is configured to cause a data processing apparatus to provide an interface comprising:
a plurality of visual icons associated with groupings of a plurality of e-mails, a grouping including a selection of the plurality of e-mails grouped based at least in part on one or more properties shared amongst the selection, and arranged in one or more star topologies comprising a primary visual icon and one or more secondary visual icons placed around a perimeter associated with the first visual icon;
adjustable visual attributes associated with the plurality of visual icons, the visual attributes being adjustable based at least in part on the shared properties of the groupings associated with the visual icons; and
one or more relationship indicators connecting the visual icons arranged in the star topologies based on relationships between the groupings of e-mails associated with the visual icons arranged in the star topologies.

19. The computer program product of claim 18 wherein the visual icons include an indication of a number of e-mails included in the groupings associated with the respective visual icons.

20. The computer program product of claim 18 wherein the interface is configured to provide, upon a selection of a visual icon, a preview of the at least a portion of the selection of e-mails included in the grouping associated with the selected visual icon.
